(19) United States
(12) Patent Application Publication
(10) Pub. No.: US 2020/0193563 A1
(43) Pub. Date: Jun. 18, 2020

(54) IMAGE PROCESSING APPARATUS AND METHOD, AND RELATED CIRCUIT

(71) Applicant: SZ DJI TECHNOLOGY CO., LTD., Shenzhen (CN)

(72) Inventors: Yao ZHAO, Shenzhen (CN); Kang YANG, Shenzhen (CN); Lin CHEN, Shenzhen (CN)

(21) Appl. No.: 16/803,364

(22) Filed: Feb. 27, 2020

Related U.S. Application Data
(63) Continuation of application No. PCT/CN2017/100027, filed on Aug. 31, 2017.

(51) Int. Cl. G06T 3/40; G06T 1/60

(52) U.S. Cl. CPC G06T 3/4007; G06T 1/60

(57) ABSTRACT

An image processing apparatus includes a first control unit, configured to determine first control information and a first interpolation coefficient for a to-be-generated target image to make a correspondence to a source image. The first control information represents data in the source image that are used to generate the target image. The image processing apparatus further includes a first pre-selection unit, configured to select a first input data corresponding to the first control information from the source image; a plurality of buffers, configured to cache the first input data; and a first filter, configured to perform interpolation calculation based on the first interpolation coefficient and the first input data stored in the plurality of buffers to generate the target image. The quantity of the plurality of buffers is greater than or equal to the quantity of taps of the first filter.

### CROSS-REFERENCE TO RELATED APPLICATION

This application is a continuation of International Application No. PCT/CN2017/100027, filed Aug. 31, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the field of image processing technology and, more particularly, relates to an image processing apparatus, an image processing method, and a related circuit.

### BACKGROUND

In computer image processing and computer graphics, image scaling refers to a process of adjusting the size of a digital image. A target image is obtained through image scaling of a source image.

In the existing image scaling scheme, the source image is cached first in a row-by-row manner, and then the buffered data is scaled accordingly, and finally the target image is obtained.

However, in the process of obtaining the target image from the source image, not all the data in the source image can be used. Therefore, the existing image scaling scheme may waste storage resources, reduce the utilization of the storage resources, and also reduce the efficiency of image processing. The disclosed image processing apparatus, method, and related circuit are directed to solve one or more problems set forth above and other problems in the art.

### SUMMARY

One aspect of the present disclosure provides an image processing apparatus. The image processing apparatus includes a first control unit, configured to determine first control information and a first interpolation coefficient for a to-be-generated target image to make a correspondence to a source image. The first control information represents data in the source image that are used to generate the target image. The image processing apparatus further includes a first pre-selection unit, configured to select, from the source image, a first input data corresponding to the first control information; a plurality of buffers, configured to cache the first input data; and a first filter, configured to perform interpolation calculation based on the first interpolation coefficient and the first input data stored in the plurality of buffers to generate the target image. The quantity of the plurality of buffers is greater than or equal to the quantity of taps of the first filter.

Another aspect of the present disclosure provides an image processing circuit related to image processing. The image processing circuit includes an output module and an image processing apparatus. The image processing apparatus includes a first control unit, configured to determine first control information and a first interpolation coefficient for a to-be-generated target image to make a correspondence to a source image. The first control information represents data in the source image that are used to generate the target image. The image processing apparatus further includes a first pre-selection unit, configured to select, from the source image, a first input data corresponding to the first control information; a plurality of buffers, configured to cache the first input data; and a first filter, configured to perform interpolation calculation based on the first interpolation coefficient and the first input data stored in the plurality of buffers to generate the target image. The quantity of the plurality of buffers is greater than or equal to the quantity of taps of the first filter. The output module is configured to output the target image generated by the image processing apparatus.

Another aspect of the present disclosure provides an image processing method. The image processing method includes determining first control information and a first interpolation coefficient for a to-be-generated target image to make a correspondence to a source image. The first control information represents data in the source image that are used to generate the target image. The image processing method further includes selecting, from the source image, a first input data corresponding to the first control information, and storing the first input data in a plurality of buffers; and using a first filter to perform interpolation calculation, based on the first interpolation coefficient and the first input data stored in the plurality of buffers, to generate the target image. The quantity of the plurality of buffers is greater than or equal to the quantity of taps of the first filter.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic structural diagram of an exemplary image processing apparatus according to some embodiments of the present disclosure;

FIG. 2 illustrates a schematic structural diagram of another exemplary image processing apparatus according to some embodiments of the present disclosure;

FIG. 3 illustrates a schematic structural diagram of another exemplary image processing apparatus according to some embodiments of the present disclosure;

FIG. 4 illustrates a schematic structural diagram of an exemplary image processing circuit according to some embodiments of the present disclosure; and

FIG. 5 illustrates a schematic flowchart of an exemplary image processing method according to some embodiments of the present disclosure.

### DETAILED DESCRIPTION OF THE EMBODIMENTS

Reference will now be made in detail to exemplary embodiments of the disclosure, which are illustrated in the accompanying drawings. Wherever possible, the same reference numbers will be used throughout the drawings to refer to the same or like parts.

In order to make the scheme of the present disclosure easy for understanding, the basic principles of image scaling is provided in the following.

Image scaling refers to the reduction and/or enlargement of an image. In the present disclosure, all images mentioned in the specification refer to bitmaps, that is, the image is described using a pixel matrix. Usually, an image to be scaled is referred to as a source image, and an image obtained by scaling the source image is referred to as a target image.

For example, a source image is a 3×3 256-level grayscale image, that is, an image with a height of three pixels and a width of three pixels. Each pixel may have a value in a range from 0 to 255. The value of a pixel may represent the brightness of the pixel: 255 represents the brightest level, i.e. white color, and 0 represents the darkest level, i.e., black color. For example, the pixel matrix of a source image may be as follows:

$$\begin{matrix}234 & 38 & 22 \\ 67 & 44 & 12 \\ 89 & 65 & 63\end{matrix}$$

In a pixel matrix, the coordinates of the pixel may be defined in a way such that x is arranged from left to right with each having an integer value starting from zero, and y is arranged from top to bottom with each also having an integer value starting from zero.

In one embodiment, as an example, a 3×3 source image may need to be enlarged into a 4×4 image. That is, the target image is an image with a height of 4 pixels and a width of 4 pixels. However, the values of the pixels in the target image are currently unknown, and requires to be calculated according to the values of the pixels in the source image. When the value of each pixel in the target image is obtained through calculation, the target image may be generated.

The basic principle of calculating the value of each pixel in the target image according to the values of the pixels in the source image is to determine the approximate pixels in the source image that correspond to each pixel in the target image first, and then calculate the value of the pixel in the target image according to the values of the approximate pixels in the source image.

For example, in the source image, when the approximate pixels that correspond to a pixel with coordinates of (x, y) in the target image include pixels with coordinates of (x1, y1), (x2, y2), (x3, y3), and (x4, y4), respectively, the value, f (x, y), of the pixel with the coordinates of (x, y) in the target image may be calculated according to the following formula:

f(x,y)=v1×f(x1,y1)+v2×f(x2,y2)+v3×f(x3,y3)+v4×f(x4,y4) (1)

where f(x1, y1), f(x2, y2), f(x3, y3), and f(x4, y4) are the values of the pixels with coordinates of (x1, y1), (x2, y2), (x3, y3), and (x4, y4), respectively in the source image, and v1, v2, v3, and v4 are interpolation coefficients.

In the current technology, there are many methods for obtaining the approximate pixels in the source image that correspond to a pixel in the target image. For example, a digital differential analyzer (DDA) may be used to obtain, corresponding to a pixel in the target image, the approximate pixels in the source image and the interpolation coefficients. There are also many methods for calculating the value of each pixel in the target image according to the values of the pixels in the source image. For example, the nearest neighbor interpolation algorithm, the bilinear interpolation algorithm, etc., and the present disclosure does not impose any limitation.

According to the existing image scaling schemes, the source image is usually first stored in a buffer sequentially in a row-by-row manner, and then a subsequent scaling process may be performed to finally obtain the target image. However, when the target image is reduced relative to the source image, it is possible to use only some of the pixel points in the source image to calculate the value of each pixel in the target image. For example, when the quantity of rows in the target image is reduced as compared to that in the source image, i.e. when scaling down in the vertical direction, it is possible that only a portion of the rows in the source image may be used for calculating the value of each pixel in the target image, and the remaining portion of the rows in the source image may be useless rows. For non-uniform scaling up, there is also a waste of hardware resource. When an existing image scaling scheme is adopted, useless row data may exist in the buffer, which reduces the utilization of the storage resources and also reduces the efficiency of image processing.

The present disclosure provides an image processing apparatus, a method, and a related circuit to save the memory usage, improve the utilization of storage resources, and further improve the image processing efficiency.

FIG. 1 illustrates a schematic structural diagram of an exemplary image processing apparatus according to some embodiments of the present disclosure. Referring to FIG. 1, the image processing apparatus 100 may include a first control unit 110, a first pre-selection unit 120, a plurality of buffers 130, and a first filter 140.

In one embodiment, the first control unit 110 may be configured to determine first control information and a first interpolation coefficient for the to-be-generated target image to make a correspondence to the source image. The first control information may represent the data in the source image that are used to generate the target image.

For example, the first control information may represent the approximate pixels in the source image that correspond to a pixel in the target image. The first interpolation coefficient may represent an interpolation coefficient that is required for an approximate pixel in the source image to obtain the pixel in the target image. For example, V1, V2, V3, and V4 in formula (1) mentioned above are interpolation coefficients.

In one embodiment, the first control unit 110 may determine the first control information and the first interpolation coefficient by using a nearest neighbor interpolation algorithm, a bilinear interpolation algorithm, or any other interpolation methods in the existing technology, and the present disclosure does not impose any limitation.

It should be understood that different scaling of the source image to the target image as well as different interpolation algorithm employed may make the meaning of the first control information different.

In one embodiment, as an example, the first control information may represent an approximate row (or an approximate column) in the source image that corresponds to a row (or a column) in the target image.

For example, the first control information may represent two rows in the source image that are adjacent to each other, two rows in the source image that are not adjacent to each other, or multiple rows in the source image that are not adjacent to each other.

In another example, the first control information may represent two columns in the source image that are adjacent to each other, two columns in the source image that are not adjacent to each other, or multiple columns in the source image that are not adjacent to each other.

It should be understood that, when the target image is scaled in only one dimension with respect to the source image, for example, only horizontally scaled (scaling in column), or only vertically scaled (scaling in row), the first control information may represent an approximate row (or an approximate column) that corresponds to a row (or column) in the target image.

In one embodiment, as another example, the first control information may represent two pixels in a same row (or column) of the source image that are adjacent to each other, two pixels in the source image that are not adjacent to each other, or multiple pixels in the source image that are not adjacent to each other.

In one embodiment, the first pre-selection unit 120 may be configured to select, from the source image, a first input data corresponding to the first control information outputted by the first control unit 110.

For example, the first control information may represent two adjacent rows in the source image, and correspondingly, the first pre-selection unit 120 may select pixels in the two adjacent rows of the source image.

In another example, the first control information may represent two adjacent columns in the source image, and correspondingly, the first pre-selection unit 120 may select pixels in the two adjacent columns of the source image.

In another example, the first control information may represent two adjacent pixels in the source image, and correspondingly, the first pre-selection unit 120 may select the two adjacent pixels in the source image.

In one embodiment, the first pre-selection unit 120 may input the selected first input data into a buffer 130 of the plurality of buffers 130.

In one embodiment, the buffer 130 may be configured to cache the first input data selected by the first pre-selection unit 120.

For example, when the first input data selected by the first pre-selection unit 120 needs to be inputted into multiple buffers 130 of the plurality of buffers 130, the input data may be inputted into the multiple buffers 130 in parallel.

Compared with the existing technology where the source image is inputted into the buffer as rows in a parallel manner, the embodiments of the present disclosure can improve the efficiency of image processing.

In one embodiment, the first filter 140 may be configured to perform an interpolation operation based on the first interpolation coefficient outputted by the first control unit 110 and the first input data stored in the buffer 130 to generate the target image.

For example, the first filter 140 may, according to the algorithm shown in formula (1), perform an interpolation operation using the first input data and the first interpolation coefficient.

It should be understood that, the data on which the first filter 140 performs the interpolation operation may be all the data in the buffer, or may be part of the data in the buffer indicated by the first control information.

It should be noted that the filter mentioned in the present disclosure may be a multi-tap filter, i.e., the quantity of taps of the filter may be at least two.

It should be understood that the quantity of taps of the filter may refer to the quantity of input and output connections of the filter. At each stage of the filter, a delayed input sample may be saved, and the input connections and output connections of each stage may be referred to as taps. For example, an M-order finite impulse response (FIR) filter may include M+1 taps.

According to the present disclosure, the quantity of the plurality of buffers 130 may be equal to a multiple of the quantity of taps of the first filter 140.

For example, when the quantity of taps of the first filter 140 is 2, the quantity of the plurality of buffers 130 may be equal to 2 or 4. In the existing technology, the source image may be stored in a plurality of row buffers in a row-by-row manner, and the output of each row buffer may be the input of the next row buffer, and the outputs of the plurality of row buffers may be inputted into the pixel array in a parallel manner. As such, the quantity of the plurality of buffers may depend on the scaling rate and the quantity of taps of the filter.

According to the present disclosure, useful data in the source image for generating the target image may be first determined. The useful data may be stored in a plurality of buffers, and then subsequent processes may be performed, such that the quantity of the plurality of buffers depends only on the quantity of taps of the first filter, and is unrelated to the scaling ratio from the source image to the target image.

For example, a vertical scaling rate from a source image to a target image may be 4:1, that is, four rows in the source image may correspond to one row in the target image. Assuming that the quantity of the taps of the filter may be 2, according to the existing technology, the quantity of the plurality of buffers may be at least 4, and among them, two buffers may store irrelevant data; however, according to the present disclosure, the quantity of the buffers may be only 2.

In one embodiment, the quantity of the plurality of buffers may be only related to the quantity of taps of the filter, and unrelated to the scaling ratio. As such, the storage pressure of the image processing apparatus may be reduced, the storage time may be reduced, and many unnecessary data may not need to be read.

Therefore, according to the present disclosure, useful data in the source image for generating the target image may be determined first. After the useful data are stored in a plurality of buffers, subsequent processes may then be performed. As such, the storage resource that is used to store irrelevant data may, to some extent, be avoided, the memory usage may be saved, the utilization of the storage resources may be improved, and the image processing efficiency may be further improved.

In one embodiment, the control unit for outputting the control information and the interpolation coefficients may be a DDA.

A DDA is essentially an accumulator that generates control information used for selecting row or column from the source image and interpolation coefficients for the filter based on the row/column count information of the target image. The initial phase and step size of the DDA may be related to the scaling ratio, where the step size may be the quantity of pixels or sub-pixels of the source image that corresponds to each time moving a pixel in the source image. In one embodiment, sub-pixels may be used when the step size is smaller than a single pixel or the step size includes a fractional part such that an addition of a step size results in falling between pixels of the original image.

In one embodiment as shown in FIG. 1, the first control unit may be implemented as a DDA.

It should be understood that the first control unit may also be implemented by other devices that are capable of realizing the function of determining the first control information and the first interpolation coefficient for the to-be-generated target image to make a correspondence to the source image.

In some embodiments, the quantity of the plurality of buffers 130 may be greater than or equal to the taps of the first filter 140. The first pre-selection unit 120 may also be configured to select, from the source image, a second input data corresponding to the first control information; and the buffer 130 may also be configured to cache the second input data when the first filter processes the first input data.

For example, the first input data may be a portion of the approximate pixels in the source image that are used to generate a portion of the pixels in the target image, and the second input data may be another portion of the approximate pixels in the source image that are used to generate another portion of the pixels in the target image. In one embodiment, when the first filter 140 performs interpolation calculation to generate a portion of the pixels of the target image, the buffer 130 may have stored the input data used for generating the other portion of the pixels of the target image. As such, the interpolation calculation of the first filter may not be terminated, and thus the efficiency of image processing may be improved.

Therefore, according to the disclosed image processing apparatus, the efficiency of image processing may be effectively improved.

In one embodiment, the image processing apparatus may further include:

a first selector, configured to store the first input data in the selected buffer 130; and

a second selector, configured to select the data stored in the buffer 130, and input the selected data into the first filter 140.

For example, the first selector may store the first input data in a buffer 130 that is currently idle (e.g. a buffer that is currently free), or may store the first input data in a designated buffer 130. For example, the image processing apparatus 100 may include four buffers: 231, 232, 233, and 234 with buffers 232 and 233 idle. The first pre-selection unit 130 may select the data of the first row and the second row in the source image as the first input data, and the first selector may select the idle buffers 232 and 233 from the 4 buffers, and then may store the data of the first row and the second row in the source image in the buffers 232 and 233.

In one embodiment, the second selector may be configured to select the data corresponding to the quantity of the taps of the first filter from the data stored in the buffer 130.

In one embodiment, the buffer 130 may also include a pixel register, and the pixel register may be configured to store, according to the first control information, some or all of the pixels stored in the buffer 130.

In one embodiment, the second selector may be configured to input the pixel selected from the pixels that are stored in the pixel register into the first filter.

It should be understood that a filter may only be responsible for scaling in one direction. When scaling the source image to the target image includes scaling in both the horizontal direction and the vertical direction, the image processing apparatus may thus need at least two filters, and accordingly, at least two control units (e.g. DDA) may be required.

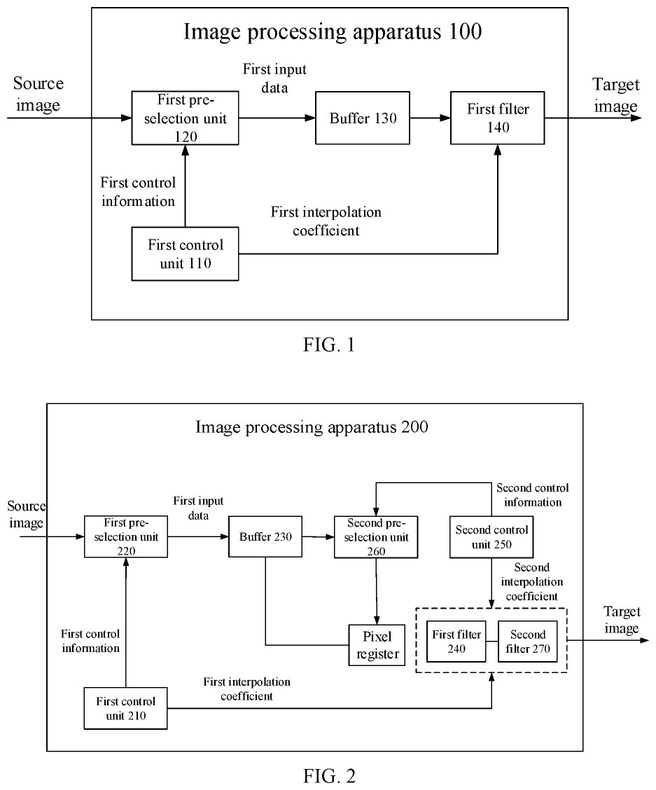

FIG. 2 illustrates a schematic structural diagram of another exemplary image processing apparatus according to some embodiments of the present disclosure. Referring to FIG. 2, the image processing apparatus may include a first control unit 210, a first pre-selection unit 220, a plurality of buffers 230, a first filter 240, a second control unit 250, a second pre-selection unit 260, and a second filter 270.

In one embodiment, the first control unit 210 may be configured to determine the first control information and the first interpolation coefficient for a row in the to-be-generated target image to make a correspondence to the source image. The first control information may represent an approximate row in the source image to which the row in the target image makes the correspondence.

For example, the first control unit 210 may determine the first control information and the first interpolation coefficient by using a nearest neighbor interpolation algorithm, a bilinear interpolation algorithm, or any other interpolation methods in the existing technology.

In one embodiment, the first pre-selection unit 220 may be configured to select, from the source image, a first input data corresponding to the first control information outputted by the first control unit 210.

For example, the first control information may represent two adjacent rows in the source image, and correspondingly, the first pre-selection unit 220 may select pixels in the two adjacent rows of the source image.

In one embodiment, the first pre-selection unit 220 may input the selected first input data into a buffer 230 of the plurality of buffers 230.

In one embodiment, the buffer 230 may be configured to cache the first input data selected by the first pre-selection unit 220.

For example, when the first input data selected by the first pre-selection unit 220 needs to be inputted into multiple buffers 230, the input data may be inputted into the multiple buffers 230 in parallel.

In one embodiment, as illustrated in FIG. 2, the buffer 230 may include a pixel register.

In one embodiment, the second control unit 250 may be configured to determine second control information and a second interpolation coefficient for a pixel in the row of the to-be-generated target image to make a correspondence to the source image. The second control information may represent an approximate pixel in the source image to which the pixel in the row of the target image makes the correspondence.

In one embodiment, the second pre-selection unit 260 may be configured to select, from the data stored in the buffer 230, a third input data corresponding to the second control information and store the third input data in the pixel register of the buffer 230.

In one embodiment, the first filter 240 and the second filter 270 may be configured to perform interpolation calculation based on the first interpolation coefficient, the second interpolation coefficient, and the data stored in the pixel register to generate the target image.

In one embodiment, the data stored in the buffer 230 may all be useful rows, and the pixels stored in the pixel register may all be usual pixels. Therefore, the resource utilization of the image processing apparatus may be effectively improved.

In one embodiment, as illustrated in FIG. 2, the second filter 270 may be configured to perform interpolation calculation based on the second interpolation coefficient and the data stored in the pixel register to obtain an intermediate result; and the first filter 240 may be configured to perform interpolation calculation based on the first interpolation coefficient and the intermediate result to generate the target image. That is, the column interpolation may be performed first, and then the row interpolation may be performed.

In one embodiment, as illustrated in FIG. 2, the second filter 270 may be configured to perform interpolation calculation based on the first interpolation coefficient and the data stored in the pixel register to obtain an intermediate result; and the first filter 240 may be configured to perform interpolation calculation based on the second interpolation coefficient and the intermediate result to generate the target image. That is, the row interpolation may be performed first, and then the column interpolation may be performed.

In one embodiment, as illustrated in FIG. 2, the image processing apparatus 200 may further include a third selector, configured to store the first input data in a buffer selected from the plurality of buffers; and a fourth selector, configured to input the pixel selected from the pixels that are stored in the pixel register into the first filter or the second filter.

In one embodiment, the control unit (the first control unit and/or the second control unit) mentioned above may be implemented as a DDA. For illustrative purposes, in the following, each control unit is described as a DDA.

In order to better understand the image processing apparatus provided in the present disclosure, the structure and operation principle of the image processing apparatus will be described in detail below with reference to an embodiment illustrated in FIG. 3.

FIG. 3 illustrates a schematic structural diagram of another exemplary image processing apparatus according to some embodiments of the present disclosure. Referring to FIG. 3, the image processing apparatus 300 may include a row DA 310, a row pre-selection unit 320, a first selector 330, a plurality of row buffers 340, a column DDA 350, a column pre-selection unit 360, a second selector 370, a horizontal filter 380, and a vertical filter 390.

In one embodiment, the row DDA 310 may be configured to calculate, corresponding to a row in the target image, the approximate row number in the source image and the row interpolation coefficient.

In one embodiment, the row pre-selection unit 320 may be configured to select, from the source image, the row corresponding to the approximate row number calculated by the row DDA 310.

In one embodiment, the first selector 330 may be configured to store the row selected by the row pre-selection unit 320 in the plurality of row buffers 340.

For example, the first selector 330 may store the row selected by the row pre-selection unit 320 in a row buffer 340 in the image processing apparatus that is currently idle.

In one embodiment, the column DDA 350 may be configured to calculate, corresponding to a pixel in a row of the target image, coordinates of an approximate pixel in the source image and the column interpolation coefficient.

For example, the column DDA 350 may be configured to calculate, corresponding to a pixel in a row of the target image, the coordinates and the column interpolation coefficient of an approximate pixel in a row (e.g., the row selected by the row pre-selection unit 320) of the source image.

It should be understood that, the column DDA 350 may be initiated after the row buffer 340 is filled with a row of pixels.

In one embodiment, the column pre-selection unit 360 may be configured to select, from the row of pixels stored in the row buffer 340, a pixel that corresponds to the coordinates of the approximate pixel calculated by the column DDA 350, and store the selected pixel in the pixel register.

In one embodiment, the pixel selected by the column pre-selection unit 360 may also be named as a column pixel.

In one embodiment, the second selector 370 may be configured to select, according to the coordinates of the approximate pixel calculated by the column DDA 350, a corresponding pixel from the pixels stored in the pixel register, and input the value of the selected pixel into the horizontal filter 380.

For example, the second selector 370 may be configured to select, according to the quantity of taps of the horizontal filter 380, a corresponding quantity of pixels from the pixels stored in the pixel register.

In one embodiment, the quantity of the taps of the horizontal filter may be 2, and correspondingly, the second selector 370 may select the values of 2 pixels from the pixel register and input the values into the horizontal filter 380.

It should be understood that, the values of the pixels in the pixel register may ultimately inputted into the horizontal filter 380 for processing.

In one embodiment, the horizontal filter 380 may be configured to perform interpolation calculation, based on the value of the pixel inputted by the second selector 370 and the column interpolation coefficient calculated by the column DDA 250, to obtain a column interpolation result, and input the column interpolation result into the vertical filter 390.

In one embodiment, the vertical filter 390 may be configured to perform interpolation calculation, based on the column interpolation result and also combining the row interpolation coefficient calculated by the row DDA 310, to obtain the target image.

Therefore, according to the present disclosure, useful data in the source image for generating the target image may be determined first. After the useful data are stored in a plurality of buffers, subsequent processes may then be performed. As such, the storage resource that is used to store irrelevant data may, to some extent, be avoided, and thus the memory usage may be saved, the utilization of the storage resources may be improved, and the image processing efficiency may be further improved.

It should be understood that in this embodiment, the row DDA corresponds to the first control unit in the above embodiment, the column DDA corresponds to the second control unit in the above embodiment; the row pre-selection unit corresponds to the first pre-selection unit in the above embodiment, and the column pre-selection unit corresponds to the second pre-selection unit in the above embodiment.

It should be noted that the order for the operation of the horizontal filter 380 and the vertical filter 390 may be interchanged, and the present disclosure does not impose any limitation.

For example, in one embodiment, after the column pre-selection unit 360 stores the selected pixel in the pixel register, the second selector 370 may select, according to the approximate row number calculated by the row DDA, the values of M pixels in a same column from the pixel registers that correspond to M row buffers, and input the selected values into the vertical filter 390. M may be equal to the quantity of taps of the vertical filter 390. The vertical filter 390 may perform interpolation calculation, based on the values of the pixels inputted by the second selector 370 and combining the row interpolation coefficient calculated by the row DDA, to obtain row interpolation result, and input the row interpolation result into the horizontal filter 380; and the horizontal filter 380 may perform interpolation calculation, based on the row interpolation result and combining the column interpolation coefficient calculated by the column DDA, to obtain the target image.

According to the disclosed image processing apparatus, the pixels stored in the plurality of pixel registers are all pixels used for generating the target image, that is, the plurality of pixel registers does not store useless pixels; the rows stored in the plurality of row buffers are all necessary row data for generating the target image, that is, the plurality of row buffers does not store useless rows. Therefore, when the vertical scaling ratio is smaller than 1, reading irrelevant rows may be avoided, the row buffers storing useless rows may be eliminated, and the read bandwidth and the memory resources may be saved; and when the horizontal scaling ratio is smaller than 1, reading irrelevant pixels may be avoided, the utilization of the subsequent filter pipeline and the write bandwidth may not be changed by the horizontal scaling, which may improve the utilization of the computing resources and make the write bandwidth more balanced.

Therefore, the disclosed image processing apparatus may be able to save the memory usage, improve the utilization of the storage resources, and further improve the image processing efficiency.

Further, the second selector may select input data for the filter (either the horizontal filter or the vertical filter) from the pixel registers. Because the pixel registers do not store useless data, the write rate of the output data may be ensured to be uniform for the filter, and does not change with the change of the scaling ratio. In the meantime, the output bandwidth of the filter may be balanced.

In one embodiment, the quantity of the pixel registers may be the same as the quantity of the taps of the filter.

In some other embodiments, the quantity of the pixel registers may be greater than the quantity of the taps of the filter. For example, the quantity of the pixel registers may be N times of the quantity of the taps of the filter, where N is an integer greater than 1.

In one embodiment, while the filter performs interpolation processing on the data stored in the current pixel register, the corresponding pixel may be selected from the buffer according to the second control information, and may be stored in an idle pixel register to be prepared for subsequent use by the filter. As such, the processing efficiency of the filter may be improved.

In the following, an example of the image scaling process in the structure shown in FIG. 3 will be described by assuming the quantity of the taps of the filter to be 2, and considering the generation of the N^{th} row of the target image.

The row DDA 310 may calculate, corresponding to the N^{th} row of the target image, the approximate row number in the source image and the row interpolation coefficient. In one embodiment, the approximate row number may be assumed to be two adjacent rows in the source image.

The row pre-selection unit 320 may select, from the source image, two adjacent rows corresponding to the approximate row number calculated by the row DDA 310.

The first selector 330 may store the two adjacent rows selected by the row pre-selection unit 320 respectively in a row buffer 0 and a row buffer 1. It should be understood that the plurality of row buffers 340 may include the row buffer 0 and the row buffer 1. For example, one of the two row buffers shown in FIG. 3 is the row buffer 0, and the other is the row buffer 1.

The column DDA 350 may calculate, corresponding to the pixels in the N^{th} row of the target image, the coordinates of the approximate pixels of the two adjacent rows and the column interpolation coefficients.

The column pre-selection unit 360 may, according to the coordinates of the approximate pixels calculated by the column DDA 350, select the corresponding adjacent pixels in the horizontal direction from the pixels stored in the row buffer 0, and may store the adjacent pixels in the pixel register 0; and select the corresponding adjacent pixels in the horizontal direction from the pixels stored in the row buffer 1, and may store the adjacent pixels in the pixel register 1.

The second selector 370 may separately input the value of the pixel register 0 in the row buffer 0 and the value of the pixel register 1 of the row buffer 1 into the horizontal filter 380.

The horizontal filter 380 may perform interpolation calculation, based on the value of the pixel register 0 inputted by the second selector 370 and combining the column interpolation coefficient outputted from the column DDA 350, to obtain a first-column interpolation result; and the horizontal filter 380 may perform interpolation calculation, based on the value of the pixel register 1 inputted by the second selector 370 and combining the column interpolation coefficient outputted from the column DDA 350, to obtain a second-column interpolation result. Then, the first-column interpolation result and the second-column interpolation result may be inputted into the vertical filter 390.

The vertical filter 390 may perform interpolation calculation based on the first-column interpolation result and the second-column interpolation result and combining the row interpolation coefficient of the row DDA 310, and after the interpolation operation is completed, the vertical filter 390 may output the N^{th} row of the target image.

In one embodiment, the vertical filter 390 may output a pixel at each time, the results of multiple outputs may form a row of pixels, and multiple rows of pixels may form the target image.

In some other embodiments, the vertical filter 390 may output a row of pixels, and the results of multiple outputs may form the target image.

In one embodiment, as illustrated in FIG. 3, the quantity of the row buffers 340 may be equal to two times the quantity of the vertical filter.

For example, the quantity of the taps of the vertical filter and the quantity of the taps of the horizontal filter may both be equal to 2, and thus the quantity of the row buffers may be equal to 4, and the quantity of the corresponding pixel registers may also be equal to 4.

In the above example of generating the N^{th} row of the target image, after the two adjacent rows of the source image that correspond to the N^{th} row of the target image are stored in a row buffer 0 and a row buffer 1, respectively, the row pre-selection unit 320 may be able to pre-select adjacent two rows of the source image that correspond to the (N+1)^{th} row of the target image, and the first selector 330 may store the two adjacent rows of the source image that correspond to the (N+1)^{th} row of the target image in a row buffer 2 and a row buffer 3, respectively in preparation for subsequent selection switching of the second selector 370.

According to the embodiment of the disclosed image processing apparatus, the utilization of the resources may be further improved, the system concurrency may also be improved, and thus the image processing efficiency may be improved.

It should be understood that for illustrative purposes, only a portion of the disclosed image processing apparatus is shown in FIG. 1, FIG. 2, and FIG. 3. That is, the image processing apparatus may include other parts that are not shown in FIG. 1, FIG. 2, and FIG. 3.

It should also be understood that the disclosed image processing apparatus may be used for the scaling of one-dimensional (linear) images, the scaling of two-dimensional images, or the scaling of three-dimensional images.

In addition, it should be understood that the disclosed image processing apparatus may be applied to the situation of returning the images captured by an aerial drone to a ground station or a remote control. For example, the image processing apparatus according to various embodiments of the present disclosure may be disposed on a drone.

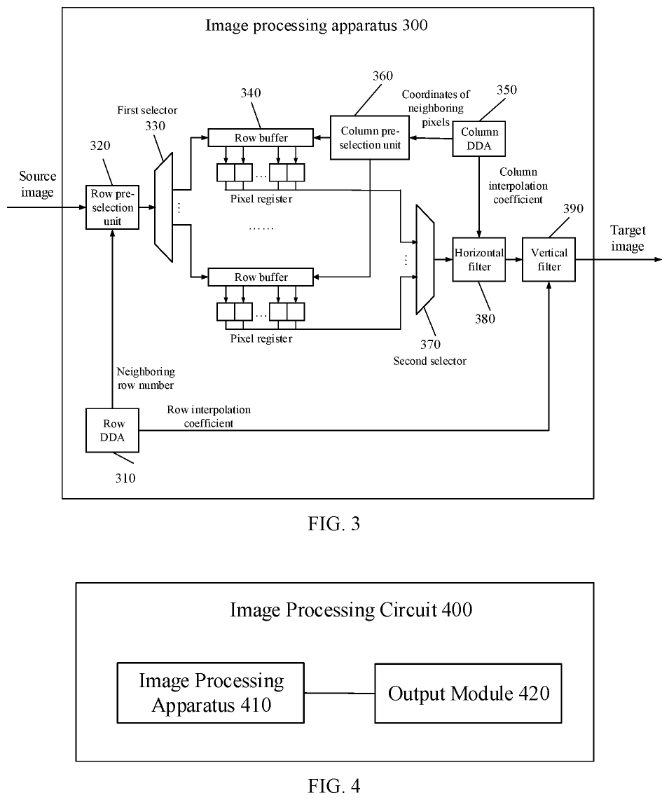

The present disclosure also provides an image processing circuit. FIG. 4 illustrates a schematic structural diagram of an exemplary image processing circuit according to some embodiments of the present disclosure. Referring to FIG. 4, the image processing circuit 400 may include an image processing apparatus 410 and an output module 420. The image processing apparatus 410 may be used to performing a scaling process for a source image to obtain a target image. The output module 420 may be used to output the target image obtained by the image processing apparatus 410. The image processing apparatus 410 may be an image processing apparatus consistent with various embodiments provided above.

The device embodiments of the present disclosure are described in detail above with reference to FIGS. 1-4, and in the following, embodiments of the image processing method according to the present disclosure will be provided. It should be understood that the description of the method embodiments corresponds to the description of the device embodiments, and therefore, portions that are not described in detail for the disclosed method can be referred to the corresponding content in the device embodiments provided above.

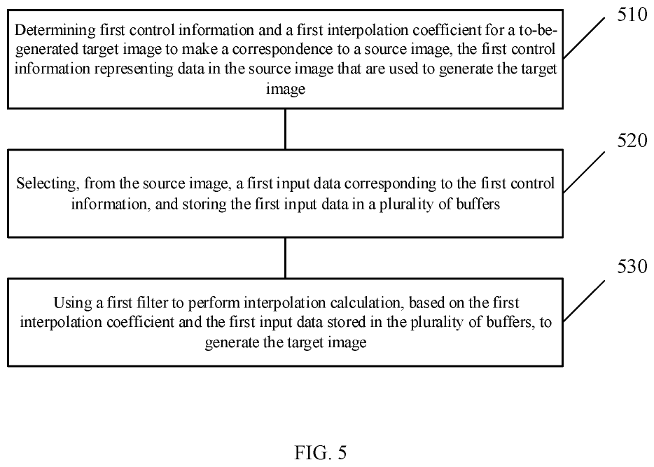

FIG. 5 illustrates a schematic flowchart of an exemplary image processing method according to some embodiments of the present disclosure. Referring to FIG. 5, the image processing method may be performed by the image processing apparatus provided above. The image processing method may include exemplary steps 510-530, which are described in detail below.

In 510 of FIG. 5, the image processing method may include determining first control information and a first interpolation coefficient for the to-be-generated target image to make a correspondence to the source image. The first control information may represent the data in the source image that are used to generate the target image.

In one embodiment, 510 of FIG. 5 may be performed by the first control unit described in the various device embodiments provided above. For example, 510 of FIG. 5 may be performed by a DDA.

In 520 of FIG. 5, the image processing method may include selecting, from the source image, a first input data corresponding to the first control information, and storing the first input data in a plurality of buffers.

The operation of selecting the first input data in 520 of FIG. 5 may be performed by the first pre-selection unit described in the various device embodiments provided above. The operation of storing the first input data in the plurality of buffers in 520 of FIG. 5 may also be performed by the first pre-selection unit, or may be performed by the first selector described in the various device embodiments provided above.

In 530 of FIG. 5, the image processing method may include using a first filter to perform interpolation calculation, based on the first interpolation coefficient and the first input data stored in the plurality of buffers, to generate the target image. The quantity of the plurality of buffers may be greater than or equal to the quantity of the taps of the first filter.

According to the disclosed image processing method, the quantity of the plurality of buffers may be only related to the quantity of taps of the filter, and unrelated to the scaling ratio. As such, the storage pressure may be reduced, and in the meantime, the utilization of the storage resources may be improved, and thus the data processing efficiency may be improved.

For example, in one embodiment, the quantity of the plurality of buffers may be greater than or equal to two times the quantity of the taps of the first filter, and the image processing method may further include selecting, from the source image, a second input data corresponding to the first control information; and when the first filer processes the first input data, storing the second input data in the plurality of buffers.

According to the disclosed image processing method, the utilization of the resources may be improved, the system concurrency may also be improved, and thus the image processing efficiency may be further improved.

In one embodiment, 520 of FIG. 5 may include storing the first input data in a selected buffer. In addition, the image processing method may further include selecting the data stored in the buffer, and inputting the selected data into the first filter.

For example, storing the first input data in the selected buffer may be performed using the first selector described in the various device embodiments provided above; and selecting the data stored in the buffer and inputting the selected data to the first filter may be performed using the second selector described in the various device embodiments provided above.

In one embodiment, the buffer may further include a pixel register, and the pixel register may be configured to store, according to the first control information, some or all of the pixels stored in the buffer.

For example, the image processing method may further include inputting the pixel selected from the pixels that are stored in the pixel register into the first filter.

In one embodiment, inputting the pixel selected from the pixels that are stored in the pixel register into the first filter may be performed using the second selector described in the various device embodiments provided above.

In one embodiment, 510 of FIG. 5 may include determining the first control information and the first interpolation coefficient for a row in the to-be-generated target image to make a correspondence to the source image, the first control information representing an approximate row in the source image to which the row in the target image makes the correspondence. The image processing method may also include determining the second control information and the second interpolation coefficient for a pixel in the row of the to-be-generated target image to make a correspondence to the source image, the second control information representing an approximate pixel in the source image to which the pixel in the row of the target image makes the correspondence; selecting, from the data stored in the buffer, a third input data corresponding to the second control information, and storing the third input data in the pixel register of the buffer. 530 of FIG. 5 may include using the second filter and combining the first filter to perform interpolation calculation, based on the first interpolation coefficient, the second interpolation coefficient, and the data stored in the pixel register, to generate the target image.

In one embodiment, 530 of FIG. 5 may include using the second filter to perform interpolation calculation based on the second interpolation coefficient and the data stored in the pixel register to obtain an intermediate result, and using the first filter to perform interpolation calculation based on the first interpolation coefficient and the intermediate result to generate the target image.

In one embodiment, 530 of FIG. 5 may include using the second filter to perform interpolation calculation based on the first interpolation coefficient and the data stored in the pixel register to obtain an intermediate result, and using the first filter to perform interpolation calculation based on the second interpolation coefficient and the intermediate result to generate the target image.

In one embodiment, the image processing method may also include inputting the pixel selected from the pixels that are stored in the pixel register into the first filter or the second filter.

Therefore, the image processing apparatus, the image processing method, and the related circuit may improve the utilization of the storage resources, and thus may further improve the image processing efficiency, and also save the memory usage.

The embodiments of the present disclosure provided above may be implemented in whole or in part by software, hardware, firmware or any other combination. When implemented by software, it may be implemented in whole or in part in the form of a computer program product. The computer program product may include one or more computer instructions. When the computer program instructions are loaded and executed on a computer, the processes or functions described in accordance with the embodiments of the present disclosure are generated in whole or in part. The computer can be a general purpose computer, a special purpose computer, a computer network, or other programmable device. The computer instructions can be stored in a computer readable storage medium or transferred from one computer readable storage medium to another computer readable storage medium. For example, the computer instructions can be transferred from a website site, computer, server or data center to another website site, computer, server or data center through a wired (e.g. coaxial cable, fiber optic, digital subscriber line (DSL)) or wireless (e.g. infrared, wireless, microwave, etc.) method. The computer readable storage medium can be any available media that can be accessed by a computer or a data storage device such as a server, data center, etc. that includes one or more available media. The available medium may be a magnetic medium (such as a floppy disk, a hard disk, or a magnetic tape), an optical medium (such as a digital video disc (DVD)), a semiconductor medium (such as a solid state disk (SSD)), etc.

Those of ordinary skill in the art should understand that the elements and algorithm steps of the various examples described in connection with the embodiments disclosed herein can be implemented in electronic hardware or a combination of computer software and electronic hardware. Whether these functions are performed in hardware or software depends on the specific application and design constraints of the technical solution. Those skilled in the art may use different methods to implement the described functionality for each particular application, but such implementation should not be considered beyond the scope of this application.

In the various embodiments provided by the present application, it should be understood that the disclosed systems, devices, and methods may be implemented in other manners. For example, the device embodiments described above are merely illustrative. For instance, in various embodiments of the present disclosure, the units are divided or defined merely according to the logical functions of the units, and in actual applications, the units may be divided or defined in another manner. For example, multiple units or components may be combined or integrated into another system, or some features can be ignored or not executed. In addition, the mutual coupling or direct coupling or communication connection shown or discussed may be an indirect coupling or communication connection through some interface, device or unit, and may be in an electrical, mechanical, or other form.

The units described as separate components may or may not be physically separated, and the components displayed as a unit may or may not be physical in a unit, that is, they may be located in one place, or may be distributed to multiple network units. Some or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. An image processing apparatus, comprising:
a first control unit, configured to determine first control information and a first interpolation coefficient for a to-be-generated target image to make a correspondence to a source image, wherein the first control information represents data in the source image that are used to generate the target image;
a first pre-selection unit, configured to select, from the source image, a first input data corresponding to the first control information;
a plurality of buffers, configured to cache the first input data; and
a first filter, configured to perform interpolation calculation based on the first interpolation coefficient and the first input data stored in the plurality of buffers to generate the target image, wherein:
a quantity of the plurality of buffers is greater than or equal to a quantity of taps of the first filter.

2. The image processing apparatus according to claim 1, wherein:
the quantity of the plurality of buffers is greater than or equal to 2 times the quantity of the taps of the first filter;
the first pre-selection unit is further configured to select, from the source image, a second input data corresponding to the first control information; and
the plurality of buffers is also configured to cache the second input data when the first filter processes the first input data.

3. The image processing apparatus according to claim 1, further including:
a first selector, configured to store the first input data in a buffer selected from the plurality of buffers; and
a second selector, configured to select data stored in the selected buffer, and input the selected data into the first filter.

4. The image processing apparatus according to claim 3, wherein:
the selected buffer includes a pixel register, wherein the pixel register is configured to store, according to the first control information, a portion or all of pixels stored in the selected buffer.

5. The image processing apparatus according to claim 4, wherein:
the second selector is configured to input a pixel selected from the pixels stored in the pixel register into the first filter.

6. The image processing apparatus according to claim 1, wherein:
the first control unit is configured to determine the first control information and the first interpolation coefficient for a row in the to-be-generated target image to make a correspondence to the source image, wherein the first control information represents an approximate row in the source image to which the row in the target image makes the correspondence; and
the image processing apparatus further includes:
a second control unit, configured to determine second control information and a second interpolation coefficient for a pixel in the row of the to-be-generated target image to make a correspondence to the source image, wherein the second control information represents an approximate pixel in the source image to which the pixel in the row of the target image makes the correspondence;
a second pre-selection unit, configured to select, from data stored in the plurality of buffers, a third input data corresponding to the second control information, and store the third input data in a pixel register of the plurality of buffers; and
a second filter, configured to perform interpolation calculation based on the first interpolation coefficient, the second interpolation coefficient, and the data stored in the pixel register to generate the target image.

7. The image processing apparatus according to claim 6, wherein:
the second filter is configured to perform interpolation calculation based on the second interpolation coefficient and the data stored in the pixel register to obtain an intermediate result; and
the first filter is configured to perform interpolation calculation based on the first interpolation coefficient and the intermediate result to generate the target image.

8. The image processing apparatus according to claim 6, wherein:
the second filter is configured to perform interpolation calculation based on the first interpolation coefficient and the data stored in the pixel register to obtain an intermediate result; and
the first filter is configured to perform interpolation calculation based on the second interpolation coefficient and the intermediate result to generate the target image.

9. The image processing apparatus according to claim 6, further including:
a third selector, configured to store the first input data in a buffer selected from the plurality of buffers; and
a fourth selector, configured to select a pixel stored in the pixel register, and input the selected pixel into the first filer or the second filter.

10. The image processing apparatus according to claim 1, wherein the first control unit is a digital differential analyzer (DDA).

11. An image processing circuit, comprising:
an output module; and
an image processing apparatus, including:
a first control unit, configured to determine first control information and a first interpolation coefficient for a to-be-generated target image to make a correspondence to a source image, wherein the first control information represents data in the source image that are used to generate the target image;
a first pre-selection unit, configured to select, from the source image, a first input data corresponding to the first control information;
a plurality of buffers, configured to cache the first input data; and
a first filter, configured to perform interpolation calculation based on the first interpolation coefficient and the first input data stored in the plurality of buffers to generate the target image, wherein:
a quantity of the plurality of buffers is greater than or equal to a quantity of taps of the first filter,
wherein the output module is configured to output the target image generated by the image processing apparatus.

12. An image processing method, comprising:
determining first control information and a first interpolation coefficient for a to-be-generated target image to make a correspondence to a source image, wherein the first control information represents data in the source image that are used to generate the target image;
selecting, from the source image, a first input data corresponding to the first control information, and storing the first input data in a plurality of buffers; and
using a first filter to perform interpolation calculation, based on the first interpolation coefficient and the first input data stored in the plurality of buffers, to generate the target image, wherein:
a quantity of the plurality of buffers is greater than or equal to a quantity of taps of the first filter.

13. The image processing method according to claim 12, wherein:
the quantity of the plurality of buffers is greater than or equal to 2 times the quantity of the taps of the first filter; and
the image processing method further includes:
selecting, from the source image, a second input data corresponding to the first control information; and
storing the second input data in the plurality of buffers, when the first filter processes the first input data.

14. The image processing method according to claim 12, wherein:
the storing the first input data in the plurality of buffers includes storing the first input data in a buffer selected from the plurality of buffers; and
the image processing method further includes:
selecting data stored in the selected buffer, and inputting the selected data into the first filter.

15. The image processing method according to claim 14, wherein:
the selected buffer includes a pixel register, wherein the pixel register is configured to store, according to the first control information, a portion or all of pixels stored in the selected buffer.

16. The image processing method according to claim 15, wherein the selecting the data stored in the selected buffer and inputting the selected data into the first filter includes:
inputting a pixel selected from the pixels stored in the pixel register into the first filter.

17. The image processing method according to claim 12, wherein:
the determining the first control information and the first interpolation coefficient for the to-be-generated target image to make the correspondence to the source image includes:
determining the first control information and the first interpolation coefficient for a row in the to-be-generated target image to make a correspondence to the source image, wherein the first control information represents an approximate row in the source image to which the row in the target image makes the correspondence;
the image processing method further includes:
determining second control information and a second interpolation coefficient for a pixel in the row of the to-be-generated target image to make a correspondence to the source image, wherein the second control information represents an approximate pixel in the source image to which the pixel in the row of the target image makes the correspondence; and
selecting, from data stored in the plurality of buffers, a third input data corresponding to the second control information, and storing the third input data in a pixel register of the plurality of buffers; and
the using the first filter to perform the interpolation calculation, based on the first interpolation coefficient and the first input data stored in the plurality of buffers, to generate the target image includes:
using a second filter and combining the first filter to perform interpolation calculation, based on the first interpolation coefficient, the second interpolation coefficient, and the data stored in the pixel register, to generate the target image.

18. The image processing method according to claim 17, wherein the using the second filter and combining the first filter to perform the interpolation calculation, based on the first interpolation coefficient, the second interpolation coefficient, and the data stored in the pixel register, to generate the target image includes:
using the second filter to perform interpolation calculation based on the second interpolation coefficient and the data stored in the pixel register to obtain an intermediate result; and
using the first filter to perform interpolation calculation based on the first interpolation coefficient and the intermediate result to generate the target image.

19. The image processing method according to claim 17, wherein the using the second filter and combining the first filter to perform the interpolation calculation, based on the first interpolation coefficient, the second interpolation coefficient, and the data stored in the pixel register, to generate the target image includes:
using the second filter to perform interpolation calculation based on the first interpolation coefficient and the data stored in the pixel register to obtain an intermediate result; and
using the first filter to perform interpolation calculation based on the second interpolation coefficient and the intermediate result to generate the target image.

20. The image processing method according to claim 17, wherein:
the storing the first input data into the plurality of buffers includes storing the first input data into a buffer selected from the plurality of buffers; and
the image processing method further includes:
selecting a pixel stored in the pixel register, and inputting the selected pixel into the first filter or the second filter.
